(19) United States
(12) Patent Application Publication
(10) Pub. No.: US 2025/0232325 A1
(43) Pub. Date: Jul. 17, 2025

(54) MULTI TENNANT SYSTEM AND METHOD FOR IDENTIFYING SOCIAL, CULTURAL, AND CONTEXTUAL BIAS FOR PERSONAL AND ORGANIZATIONAL USERS

(71) Applicant: Dwayne Ray Cormier, Media, PA (US)

(72) Inventor: Dwayne Ray Cormier, Media, PA (US)

(21) Appl. No.: 19/027,488

(22) Filed: Jan. 17, 2025

Related U.S. Application Data
(60) Provisional application No. 63/621,826, filed on Jan. 17, 2024.

(51) Int. Cl. G06Q 30/0203

(52) U.S. Cl. CPC G06Q 30/0203

(57) ABSTRACT

A system for identifying social, cultural, and contextual bias (i.e., friction illumination) for personal and organizational users is disclosed, including at least one user computing device in operable connection with a user network. An application server is in operable communication with the user network to host an application program for identifying social, cultural, and contextual bias for personal and organizational users. The application program having a user interface module for providing access to the application program via the at least one user computing device. An AI engine provides qualitative analysis in a user interface for identifying social, cultural and contextual bias and provide analysis related to the social, cultural and contextual bias.

### CROSS-REFERENCE TO RELATED APPLICATIONS

The present application claims priority to U.S. Provisional Application No. 63/621,826 filed Jan. 17, 2024, titled “MULTI-TENNANT SYSTEM AND METHOD FOR IDENTIFYING SOCIAL, CULTURAL, AND CONTEXTUAL BIAS FOR PERSONAL AND ORGANIZATIONAL USERS,” which is hereby incorporated by reference in its entirety.

### TECHNICAL FIELD

The embodiments disclosed herein generally relate to computerized systems and methods for identifying and analyzing social, cultural, and contextual bias for personal and organizational users using qualitative and AI-enhanced techniques.

### BACKGROUND

Q-methodology, often known as Q-sorting, is a research technique used to study people's “subjectivity” (i.e., their viewpoints). William Stephenson specifically developed Q-methodology for this purpose in the 1930s, combining elements of factor analysis and correlation theory. The Q-methodology is often used in psychology and social sciences but can be applied in various other fields as well, including political science, media studies, and healthcare.

Q-sorting works by first developing a Q-sample. Researchers create a sample of statements related to the topic being studied. These can range from opinion statements to factual statements and can be derived from interviews, literature reviews, or other relevant sources. Next, sorting is performed as participants (also known as P-set) are given these statements printed on individual cards and asked to sort them into categories along a continuum from “most agree” to “most disagree” according to their own perspectives. This is typically done on a Q-sort board that has a quasi-normal distribution, forcing the participants to consider the relative importance of the statements.

The sorted cards represent the participants' views on the subject matter. These sorts are then subject to factor analysis, which identifies common factors or dimensions that can explain variations in the Q-sorts. Researchers may then interpret the factors to understand the different viewpoints that exist within the population sampled.

Q-sampling provides subjectivity by focusing on subjective experience and viewpoints and may be useful even with a small number of participants because the focus is on the diversity of viewpoints rather than generalizability. The use of factor analysis differentiates it from more traditional survey techniques, allowing researchers to uncover the underlying patterns in how people think about a topic. Although Q-sampling starts with qualitative data (statements, opinions), it uses quantitative methods (factor analysis) for sorting and understanding this data, making it a mixed-methods approach.

The methodology is highly useful when researchers are interested in exploring the range and nuances of viewpoints around a particular issue. Q-sampling is particularly well-suited for identifying shared perspectives within groups and is sometimes used in conjunction with other methods to provide a more comprehensive view of public opinion or perceptions.

### SUMMARY OF THE INVENTION

This summary is provided to introduce a variety of concepts in a simplified form that is further disclosed in the detailed description of the embodiments. This summary is not intended for determining the scope of the claimed subject matter.

The embodiments provided herein disclose computerized systems and methods for identifying and analyzing social, cultural, and contextual bias for personal and organizational users using qualitative and AI-enhanced techniques. The system includes at least one user computing device in operable connection with a user network. An application server is in operable communication with the user network to host an application program for identifying social, cultural, and contextual bias for personal and organizational users. The application program having a user interface module for providing access to the application program via the at least one user computing device. An AI engine provides qualitative analysis in a user interface for identifying social, cultural and contextual bias and provide analysis related to the social, cultural and contextual bias.

In some aspects, a display module provides one or more cluster activities comprised of at least one of the following: a survey, a question, and an interview transcript.

In some aspects, the AI engine operates a scoring engine to score one or more qualitative components, wherein the one or more qualitative components are comprised of the social, the cultural and the contextual bias, and wherein the one or more qualitative components are gathered from the one or more cluster activities.

In some aspects, a cluster engine is in operable communication with the scoring engine and the AI engine evaluate and improve scoring of the social bias, the cultural bias, and the contextual bias.

In some aspects, a collaboration engine is in operable communication with the scoring engine and the cluster engine, wherein the collaboration engine integrates two or more data sources.

In some aspects, a visualization and reporting engine are in operable communication with the display module to display results associated with the one or more cluster activities.

In some embodiments, a business intelligence engine securely manages one or more responses to the one or more cluster activities.

In some embodiments, a data exchange module enables transmission of data between two or more data sources.

In some aspects, the system utilizes organizational friction (i.e., bias) in the sorting process. This sorting process determines if there are mismatches, incorrect ratings, etc. and may sort each by importance (e.g., such as by sorting from most to least importance.

In some aspects, the system is a multi-tenant system to perform the functionalities described herein.

The system includes proprietary democratic methodologies which include a collective intelligence approach incorporating experts, users, and pre-trained AI agents to refine large language models. AI Agents Specialized in Social Science or Organizational Frameworks are trained to be socially and culturally aware, providing deeper insights into qualitative data.

The system provides social science integration which uses established social science frameworks like Cultural Proficiency to guide the AI training and analytics process.

User interfaces are designed with a focus on intuitive interaction and easy navigation, tailored to individual user needs.

A friction illumination (this may also be referred to as bias illumination) and recommendation engine identifies but also offering actionable recommendations to mitigate biases, thereby fostering more inclusive environments. platform has the ability to adapt its analysis based on the social and cultural advantages. As used herein, the term friction illumination may relate to bias or knowledge gaps.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a system architecture diagram of the network infrastructure, according to some embodiments;

FIG. 2 illustrates a block diagram of the application program and computing system, according to some embodiments;

FIG. 3 illustrates a flowchart of the system architecture, according to some embodiments;

FIG. 4 illustrates a flowchart of the user flow, according to some embodiments;

FIG. 5 illustrates a flowchart of the user flow, according to some embodiments;

FIG. 6 illustrates a flowchart of the user flow, according to some embodiments;

FIG. 7 illustrates a flowchart of the user flow, according to some embodiments;

FIG. 8 illustrates a flowchart of the user flow, according to some embodiments;

FIG. 9 illustrates a block diagram of the system's software architecture, according to some embodiments;

FIG. 10 illustrates a schematic of the system's AI cloud architecture, according to some embodiments;

FIG. 11 illustrates a schematic of the system's data flow, according to some embodiments;

FIG. 12 illustrates a screenshot of the user interface, according to some embodiments;

FIG. 13 illustrates a screenshot of the user interface, according to some embodiments;

FIG. 14 illustrates a screenshot of the user interface, according to some embodiments;

FIG. 15 illustrates a screenshot of the user interface, according to some embodiments;

FIG. 16 illustrates a screenshot of the user interface, according to some embodiments;

FIG. 17 illustrates a screenshot of the user interface, according to some embodiments;

FIG. 18 illustrates a screenshot of the user interface, according to some embodiments;

FIG. 19 illustrates a screenshot of the user interface, according to some embodiments;

FIG. 20 illustrates a screenshot of the user interface, according to some embodiments;

FIG. 21 illustrates a screenshot of the user interface, according to some embodiments;

FIG. 22 illustrates a screenshot of the user interface, according to some embodiments; and

FIG. 23 illustrates a screenshot of the user interface, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing in detail exemplary embodiments, it is noted that the embodiments reside primarily in combinations of components related to particular devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments herein relate to systems and methods for a cloud-based application which uses artificial intelligence-enhanced qualitative analysis tools embedded in user interfaces for identifying social, cultural, and contextual bias for personal and organizational users. The system provides a cloud-based application accessible via web interfaces, making it easily available for both individual and organizational users. Its core is built on advanced Artificial Intelligence (AI) algorithms that specialize in qualitative analysis. These algorithms are trained using a proprietary democratic methodology that incorporates feedback from experts, end-users, and other pre-trained AI agents. This ensures that the AI model is continually updated and refined for optimum performance.

As used herein, the term friction illumination may relate to bias or knowledge gaps.

In some embodiments, the system features a human-centric design that prioritizes ease of use. It integrates with various data input methods and presents information in an easily digestible format, making use of graphical elements like charts, graphs, and dynamic data visualization. The interface is intended to be user-friendly, ensuring that individuals from various sectors like education, politics, law enforcement, and healthcare can navigate it easily.

The primary function of the system is to identify and analyze biases in various contexts, ranging from social and cultural to specific sectors like politics, healthcare, and law enforcement. The platform employs AI agents trained in different social science or organizational frameworks to perform this analysis.

To perform data collection, the system collects qualitative data from users through its interactive interfaces. This could be text, survey responses, or other forms of data that encapsulate human opinions, attitudes, and behaviors. Once the data is collected, it is then analyzed by AI agents to identify patterns or biases. These agents are trained to recognize intricate social, cultural, and contextual norms and deviations.

Based on the analysis, the system generates insights that can help users understand the underlying biases that may be present in the examined dataset. These insights are tailored to individual or organizational objectives. After generating insights, the platform offers actionable recommendations. These could be strategies to counter identified biases or approaches to foster more inclusive language and actions within a particular context.

The system is designed to be versatile, catering to various sectors including education, healthcare, politics, law enforcement, social science research, organization culture, among others.

Educators may use the system to analyze classroom dynamics or curricula for biases and then implement the recommended changes.

Healthcare providers may utilize the system to understand patient data more holistically, taking into account social and cultural biases that may affect patient care.

Policy-makers can analyze public opinion and discourse to make more inclusive policies. Similarly, law enforcement agencies can use it to analyze their interactions and operations for any form of bias, which can then be rectified.

Researchers can employ the functionalities of the system to run complex analyses on large datasets, which can then inform broader social studies. Further, companies can use the system to perform internal audits on corporate culture, providing insights into areas for improvement in diversity and inclusion.

In some embodiments, the system may be extended into several other applications beyond bias identification. Below are some alternative or additional methods, materials, or functionalities that could be integrated into the system's logic to make it versatile for different kinds of research and analysis.

In some embodiments, the system may offer AI-driven personality tests that not only quantify traits but also identify the underlying cultural and social biases affecting those traits.

In some embodiments, the system may incorporate questionnaires and diagnostic tools to analyze mental health conditions and social stigmas related to them.

In some embodiments, the system may use machine learning to predict and analyze human behavior based on historical data and social context.

In some embodiments, the system uses Natural Language Processing (NLP) techniques to scan and analyze social media, reviews, and open-ended survey responses to gauge public sentiment about products or brands.

In some embodiments, the system applies machine learning algorithms to identify emerging market trends based on qualitative data such as news articles, academic papers, or social media mentions.

In some embodiments, the system integrates data scraping methods to collect information on competitors and use AI to perform SWOT (Strengths, Weaknesses, Opportunities, Threats) analyses.

In some embodiments, the system integrates functionalities for coding and analyzing ethnographic or observational data, including video and audio transcripts. Longitudinal Analysis: Implement features that allow the tracking of social and cultural shifts over time within a particular group or community.

In some embodiments, the system provides tools that allow for the multi-dimensional analysis of how various social categorizations intersect in individual lives.

In some embodiments, the system uses AI methodologies to conduct sentiment analysis during political events like debates or elections, providing real-time insights into public opinion.

In some embodiments, the system implements machine learning models to forecast election outcomes or public reactions to proposed policies based on past data and current sentiment.

In some embodiments, the system integrates geolocation data to understand how sentiments and opinions vary across different geographic locations.

By adding these alternative or additional functionalities, the system's logic could significantly extend its utility across a broad range of sectors and use-cases, thereby increasing its value proposition.

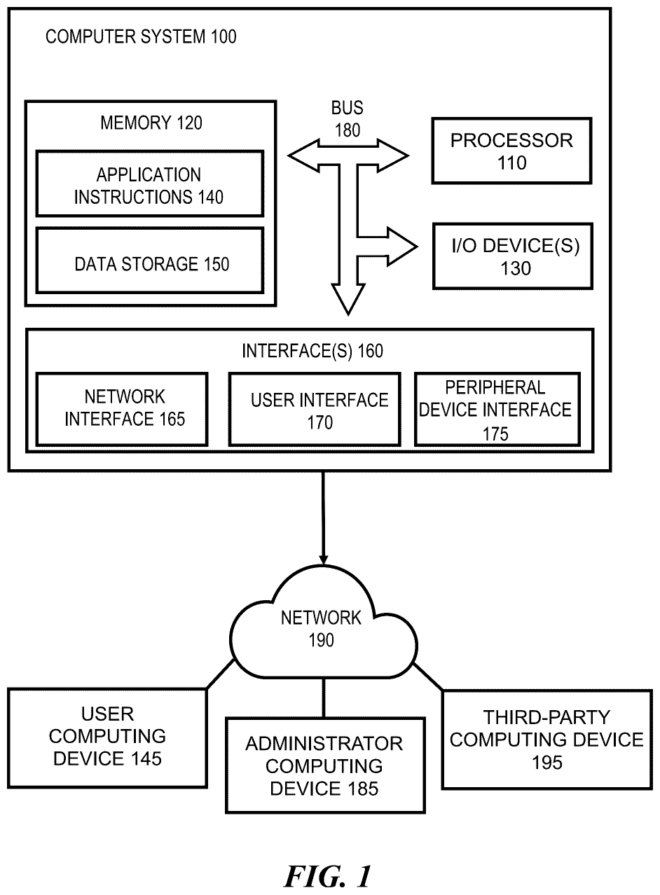

FIG. 1 illustrates an example of a computer system 100 that may be utilized to execute various procedures, including the processes described herein. The computer system 100 comprises a standalone computer or mobile computing device, a mainframe computer system, a workstation, a network computer, a desktop computer, a laptop, or the like. The computing device 100 can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

In some embodiments, the computer system 100 includes one or more processors 110 coupled to a memory 120 through a system bus 180 that couples various system components, such as an input/output (I/O) devices 130, to the processors 110. The bus 180 may be any of several types of bus structures including a memory bus or memory controller, a peripheral bus, and a local bus using any of a variety of bus architectures. For example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

In some embodiments, the computer system 100 includes one or more input/output (I/O) devices 130, such as video device(s) (e.g., a camera), audio device(s), and display(s) are in operable communication with the computer system 100. In some embodiments, similar I/O devices 130 may be separate from the computer system 100 and may interact with one or more nodes of the computer system 100 through a wired or wireless connection, such as over a network interface.

Processors 110 suitable for the execution of computer readable program instructions include both general and special purpose microprocessors and any one or more processors of any digital computing device. For example, each processor 110 may be a single processing unit or a number of processing units and may include single or multiple computing units or multiple processing cores. The processor(s) 110 can be implemented as one or more microprocessors, microcomputers, microcontrollers, digital signal processors, central processing units, state machines, logic circuitries, and/or any devices that manipulate signals based on operational instructions. For example, the processor(s) 110 may be one or more hardware processors and/or logic circuits of any suitable type specifically programmed or configured to execute the algorithms and processes described herein. The processor(s) 110 can be configured to fetch and execute computer readable program instructions stored in the computer-readable media, which can program the processor(s) 110 to perform the functions described herein.

In this disclosure, the term “processor” can refer to substantially any computing processing unit or device, including single-core processors, single-processors with software multithreading execution capability, multi-core processors, multi-core processors with software multithreading execution capability, multi-core processors with hardware multithread technology, parallel platforms, and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures, such as molecular and quantum-dot based transistors, switches, and gates, to optimize space usage or enhance performance of user equipment. A processor can also be implemented as a combination of computing processing units.

In some embodiments, the memory 120 includes computer-readable application instructions 150, configured to implement certain embodiments described herein, and a database 150, comprising various data accessible by the application instructions 140. In some embodiments, the application instructions 140 include software elements corresponding to one or more of the various embodiments described herein. For example, application instructions 140 may be implemented in various embodiments using any desired programming language, scripting language, or combination of programming and/or scripting languages (e.g., Android, C, C++, C#, JAVA, JAVASCRIPT, PERL, etc.).

In this disclosure, terms “store,” “storage,” “data store,” data storage,” “database,” and substantially any other information storage component relevant to operation and functionality of a component are utilized to refer to “memory components,” which are entities embodied in a “memory,” or components comprising a memory. Those skilled in the art would appreciate that the memory and/or memory components described herein can be volatile memory, nonvolatile memory, or both volatile and nonvolatile memory. Nonvolatile memory can include, for example, read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include, for example, RAM, which can act as external cache memory. The memory and/or memory components of the systems or computer-implemented methods can include the foregoing or other suitable types of memory.

Generally, a computing device will also include, or be operatively coupled to receive data from or transfer data to, or both, one or more mass data storage devices; however, a computing device need not have such devices. The computer readable storage medium (or media) can be a tangible device that can retain and store instructions for use by an instruction execution device. The computer readable storage medium can be, for example, an electronic storage device, a magnetic storage device, an optical storage device, an electromagnetic storage device, a semiconductor storage device, or any suitable combination of the foregoing. A non-exhaustive list of more specific examples of the computer readable storage medium can include: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. In this disclosure, a computer readable storage medium is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In some embodiments, the steps and actions of the application instructions 140 described herein are embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

In some embodiments, the application instructions 140 for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The application instructions 140 can execute entirely on the user's computer, partly on the user's computer, as a stand-alone software package, partly on the user's computer and partly on a remote computer, or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

In some embodiments, the application instructions 140 can be downloaded to a computing/processing device from a computer readable storage medium, or to an external computer or external storage device via a network 190. A network adapter card or network interface in each computing/processing device receives computer readable program instructions from the network and forwards the computer readable application instructions 140 for storage in a computer readable storage medium within the respective computing/processing device.

In some embodiments, the computer system 100 includes one or more interfaces 160 that allow the computer system 100 to interact with other systems, devices, or computing environments. In some embodiments, the computer system 100 comprises a network interface 165 to communicate with a network 190. In some embodiments, the network interface 165 is configured to allow data to be exchanged between the computer system 100 and other devices attached to the network 190, such as other computer systems, or between nodes of the computer system 100. In various embodiments, the network interface 165 may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol. Other interfaces include the user interface 170 and the peripheral device interface 175.

In some embodiments, the network 190 corresponds to a local area network (LAN), wide area network (WAN), the Internet, a direct peer-to-peer network (e.g., device to device Wi-Fi, Bluetooth, etc.), and/or an indirect peer-to-peer network (e.g., devices communicating through a server, router, or other network device). The network 190 can comprise copper transmission cables, optical transmission fibers, wireless transmission, routers, firewalls, switches, gateway computers and/or edge servers. The network 190 can represent a single network or multiple networks. In some embodiments, the network 190 used by the various devices of the computer system 100 is selected based on the proximity of the devices to one another or some other factor. For example, when a first user device and second user device are near each other (e.g., within a threshold distance, within direct communication range, etc.), the first user device may exchange data using a direct peer-to-peer network. But when the first user device and the second user device are not near each other, the first user device and the second user device may exchange data using a peer-to-peer network (e.g., the Internet). The Internet refers to the specific collection of networks and routers communicating using an Internet Protocol (“IP”) including higher level protocols, such as Transmission Control Protocol/Internet Protocol (“TCP/IP”) or the Uniform Datagram Packet/Internet Protocol (“UDP/IP”).

Any connection between the components of the system may be associated with a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. As used herein, the terms “disk” and “disc” include compact disc (CD), laser disc, optical disc, digital versatile disc (DVD), floppy disk, and Blu-ray disc; in which “disks” usually reproduce data magnetically, and “discs” usually reproduce data optically with lasers. Combinations of the above should also be included within the scope of computer-readable media. In some embodiments, the computer-readable media includes volatile and nonvolatile memory and/or removable and non-removable media implemented in any type of technology for storage of information, such as computer-readable instructions, data structures, program modules, or other data. Such computer-readable media may include RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the computing device, the computer-readable media may be a type of computer-readable storage media and/or a tangible non-transitory media to the extent that when mentioned, non-transitory computer-readable media exclude media such as energy, carrier signals, electromagnetic waves, and signals per se.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

In some embodiments, the system can also be implemented in cloud computing environments. In this context, “cloud computing” refers to a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

As used herein, the term “add-on” (or “plug-in”) refers to computing instructions configured to extend the functionality of a computer program, where the add-on is developed specifically for the computer program. The term “add-on data” refers to data included with, generated by, or organized by an add-on. Computer programs can include computing instructions, or an application programming interface (API) configured for communication between the computer program and an add-on. For example, a computer program can be configured to look in a specific directory for add-ons developed for the specific computer program. To add an add-on to a computer program, for example, a user can download the add-on from a website and install the add-on in an appropriate directory on the user's computer.

In some embodiments, the computer system 100 may include a user computing device 145, an administrator computing device 185 and a third-party computing device 195 each in communication via the network 190. The user computing device 145 may be utilized a user to interact with the various functionalities of the system including to perform patient rounds, handoff patient rounding responsibility, perform biometric verification tasks, and other associated tasks and functionalities of the system. The administrator computing device 185 is utilized by an administrative user to moderate content and to perform other administrative functions. The third-party computing device 195 may be utilized by third parties to receive communications from the user computing device, transmit communications to the user via the network, and otherwise interact with the various functionalities of the system.

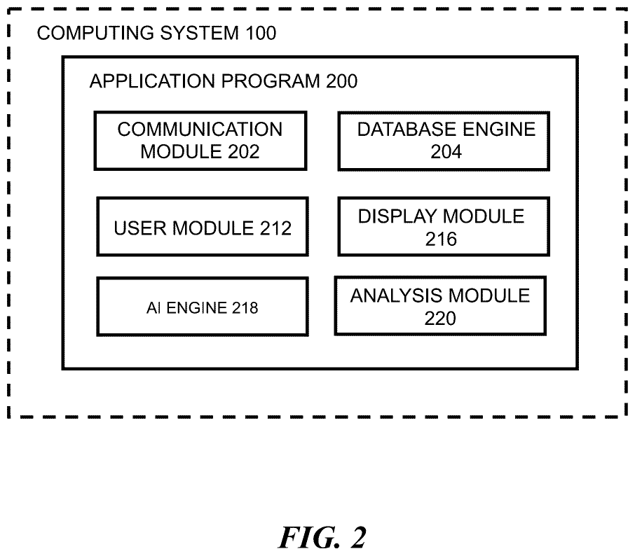

FIG. 2 illustrates an example computer architecture for the application program 200 operated via the computer system 100. The computer system 100 comprises several modules and engines configured to execute the functionalities of the application program 200, and a database engine 204 configured to facilitate how data is stored and managed in one or more databases. In particular, FIG. 2 is a block diagram showing the modules and engines needed to perform specific tasks within the application program 200.

Referring to FIG. 2, the computing system 100 operating the application program 200 comprises one or more modules having the necessary routines and data structures for performing specific tasks, and one or more engines configured to determine how the platform manages and manipulates data. In some embodiments, the application program 200 comprises one or more of a communication module 202, a database engine 204, a user module 212, a display module 216, an AI engine 218, and an analysis module 220.

In some embodiments, the communication module 202 is configured for receiving, processing, and transmitting a user command and/or one or more data streams. In such embodiments, the communication module 202 performs communication functions between various devices, including the user computing device 145, the administrator computing device 185, and a third-party computing device 195. In some embodiments, the communication module 302 is configured to allow one or more users of the system, including a third-party, to communicate with one another. In some embodiments, the communications module 202 is configured to maintain one or more communication sessions with one or more servers, the administrative computing device 185, and/or one or more third-party computing device(s) 195. In some embodiments, the communication module 202 may allow athletes, sponsors, third-parties, and non-profits to communicate with one another.

In some embodiments, a database engine 204 is configured to facilitate the storage, management, and retrieval of data to and from one or more storage mediums, such as the one or more internal databases described herein. In some embodiments, the database engine 204 is coupled to an external storage system. In some embodiments, the database engine 204 is configured to apply changes to one or more databases. In some embodiments, the database engine 204 comprises a search engine component for searching through thousands of data sources stored in different locations.

The user module 212 may store user preferences including the user account information, historical usage data, user personal information, and the like.

In some embodiments, the display module 216 is configured to display one or more graphic user interfaces, including, e.g., one or more user interfaces, one or more consumer interfaces, one or more video presenter interfaces, etc. In some embodiments, the display module 216 is configured to temporarily generate and display various pieces of information in response to one or more commands or operations. The various pieces of information or data generated and displayed may be transiently generated and displayed, and the displayed content in the display module 216 may be refreshed and replaced with different content upon the receipt of different commands or operations in some embodiments. In such embodiments, the various pieces of information generated and displayed in a display module 216 may not be persistently stored.

In some embodiments, the AI engine 218 provides qualitative analysis in a user interface for identifying social, cultural and contextual bias. The AI engine employs proprietary democratic methodologies which include a collective intelligence approach incorporating experts, users, and pre-trained AI agents to refine large language models. AI Agents Specialized in Social Science or Organizational Frameworks are trained to be socially and culturally aware, providing deeper insights into qualitative data. The analysis module 220 provides analysis of data integrated with the AI engine 218.

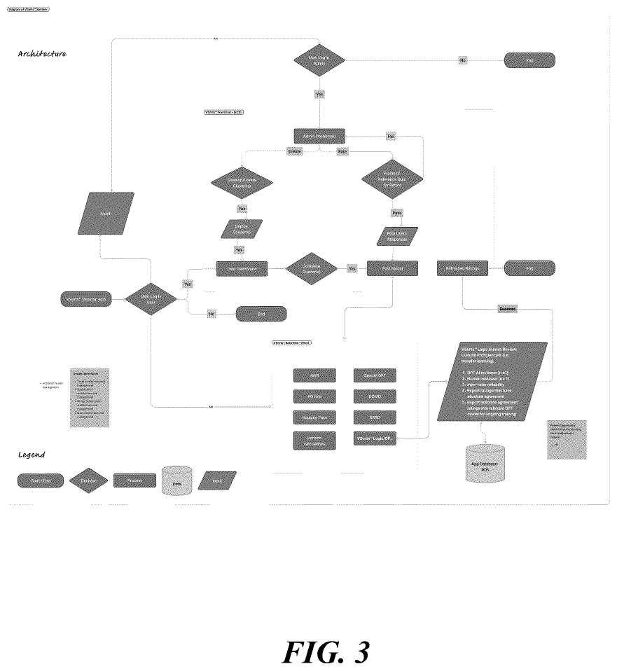

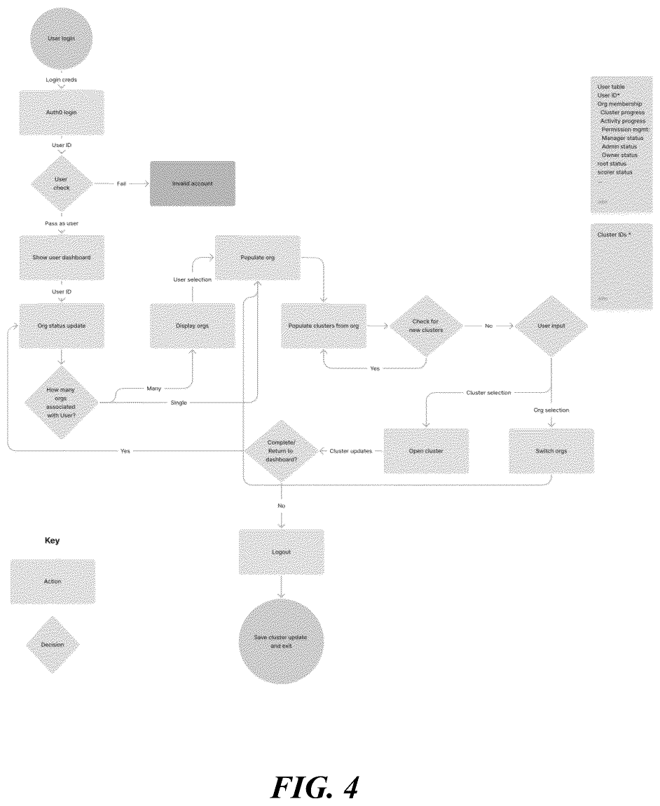

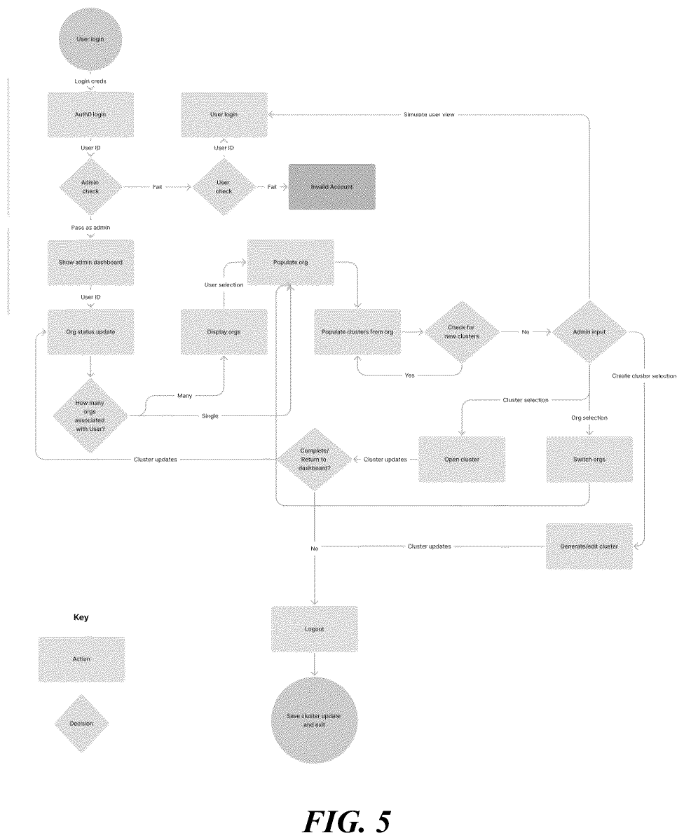

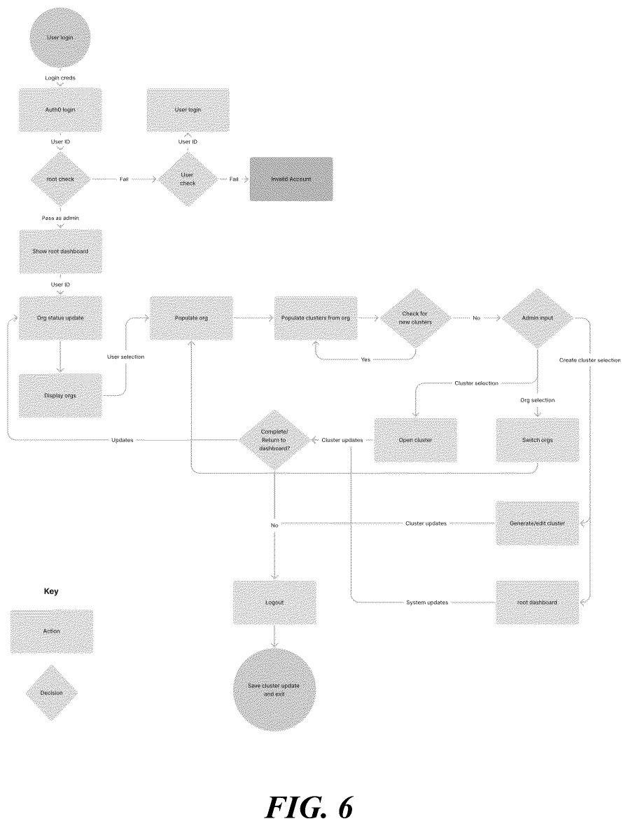

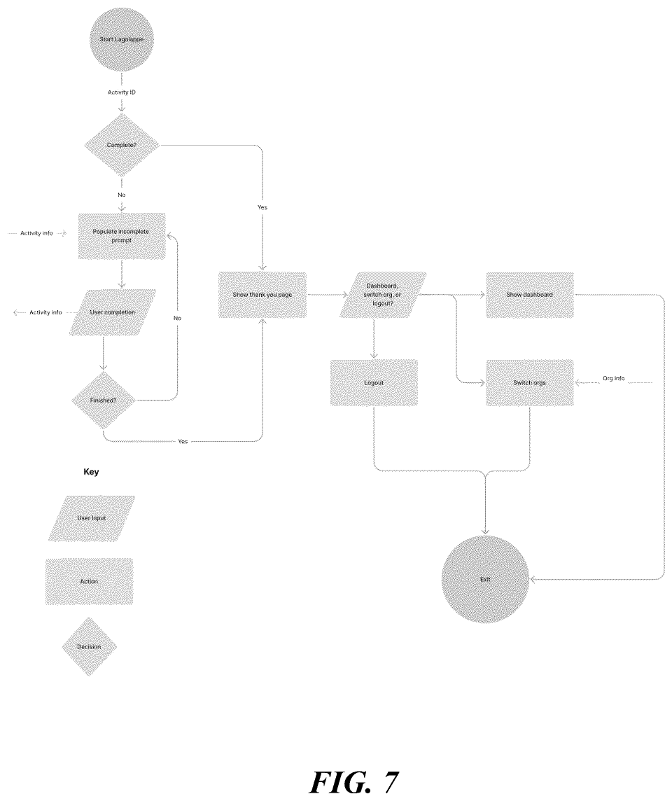

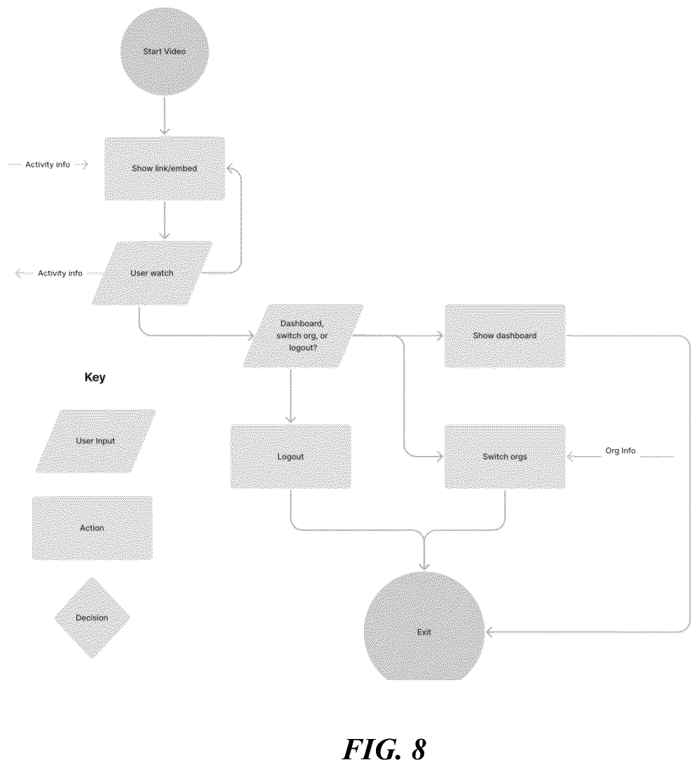

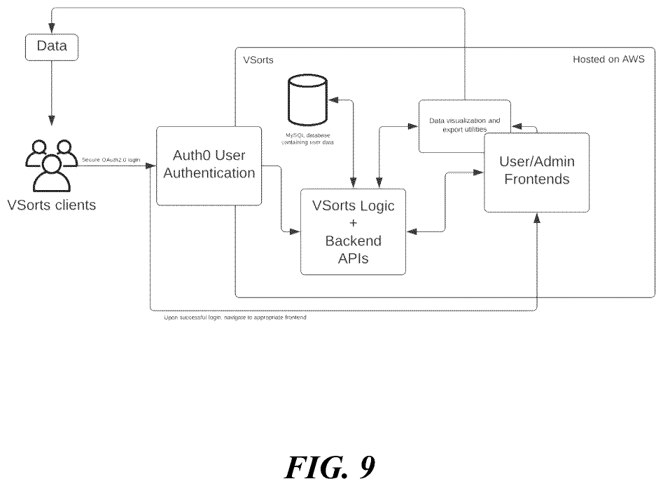

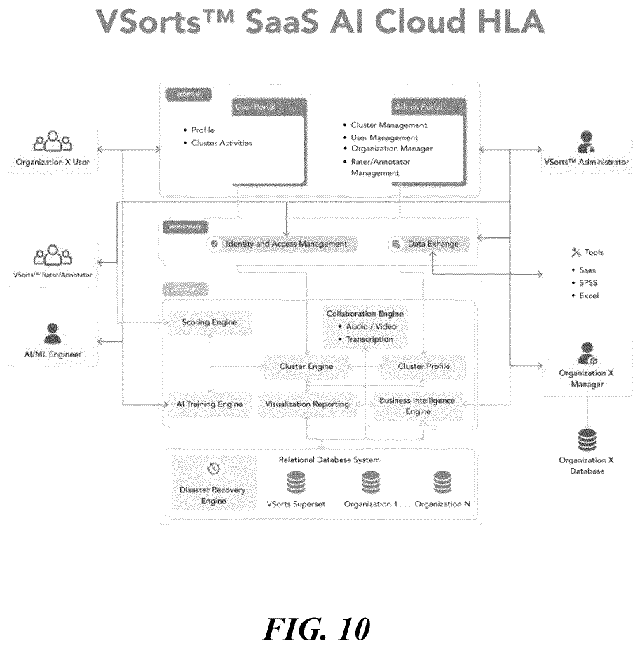

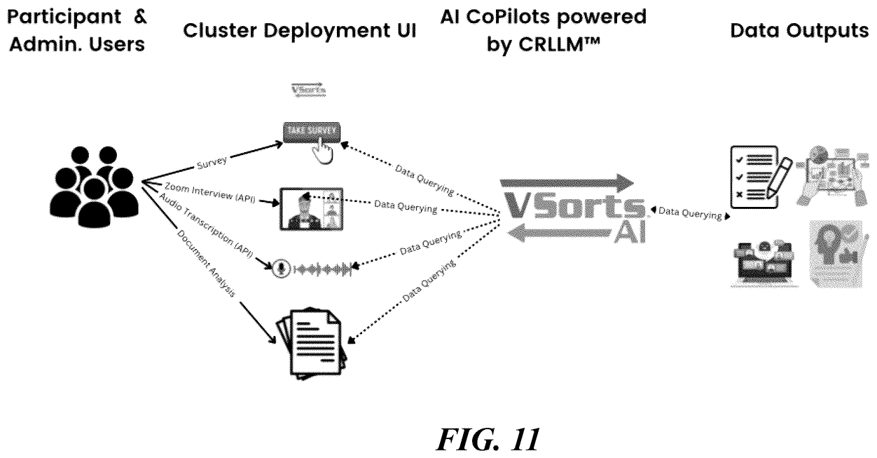

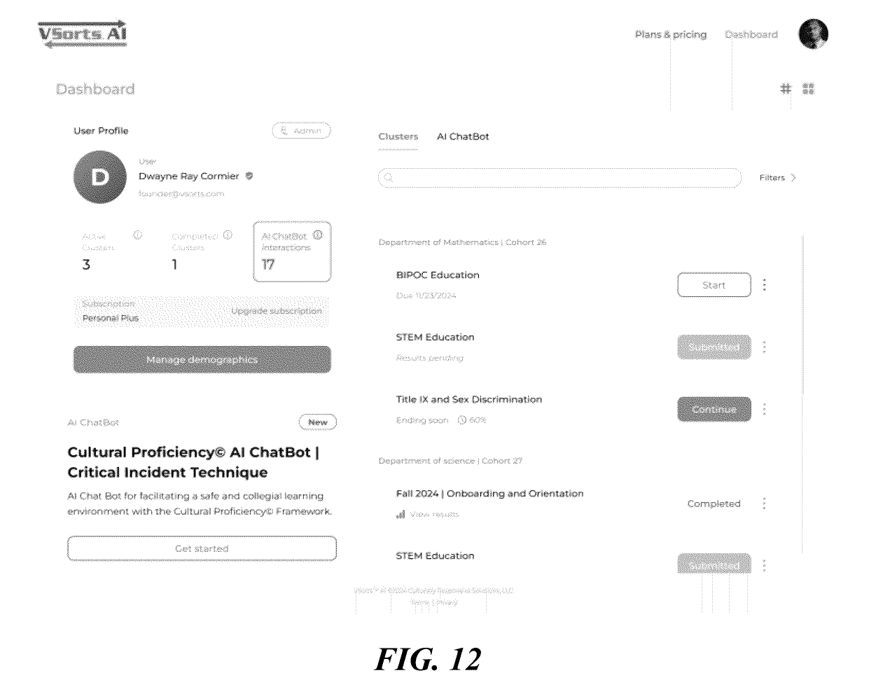

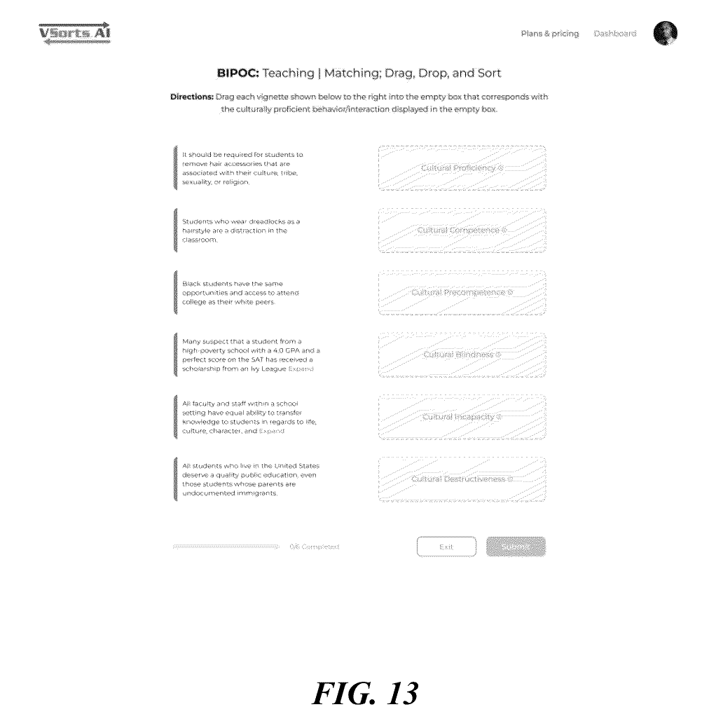

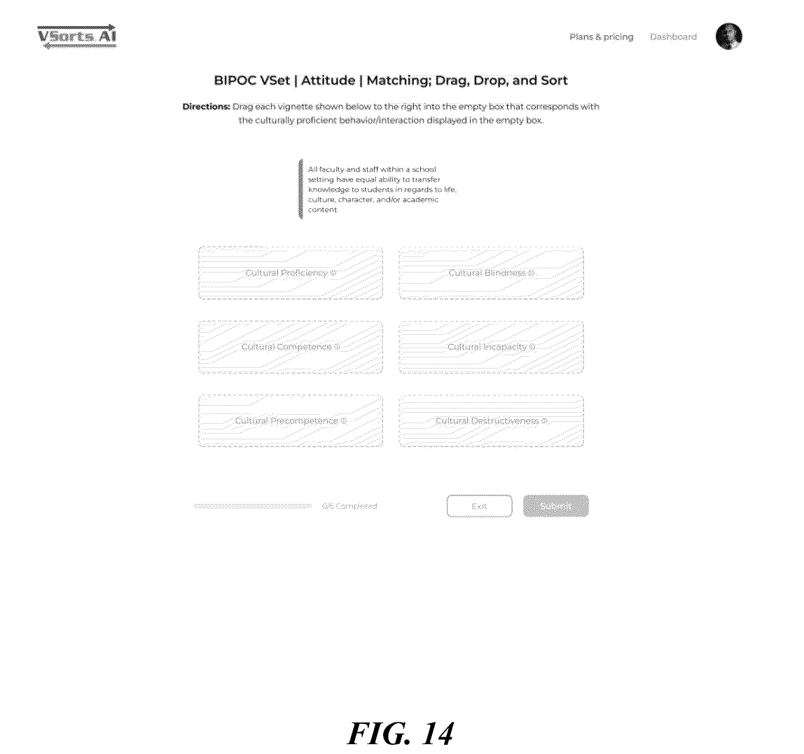

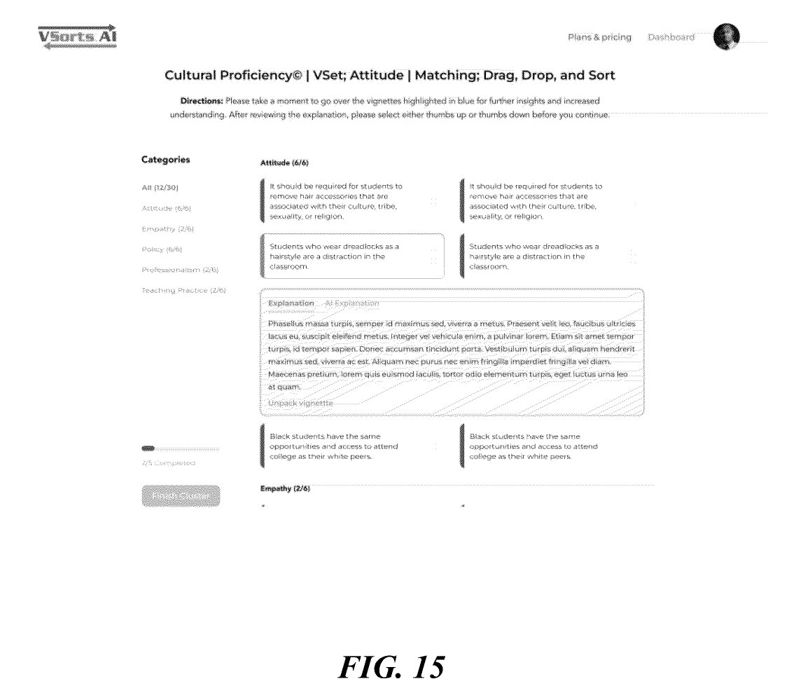

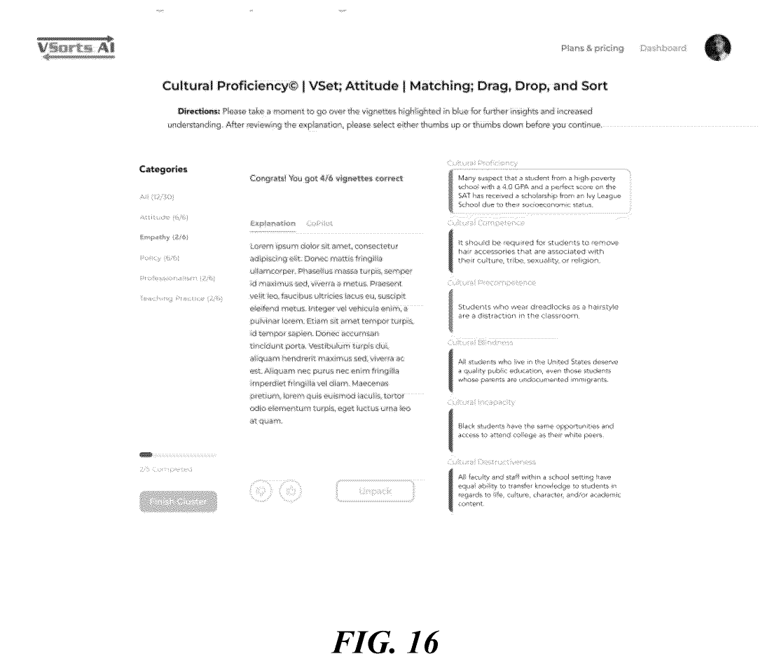

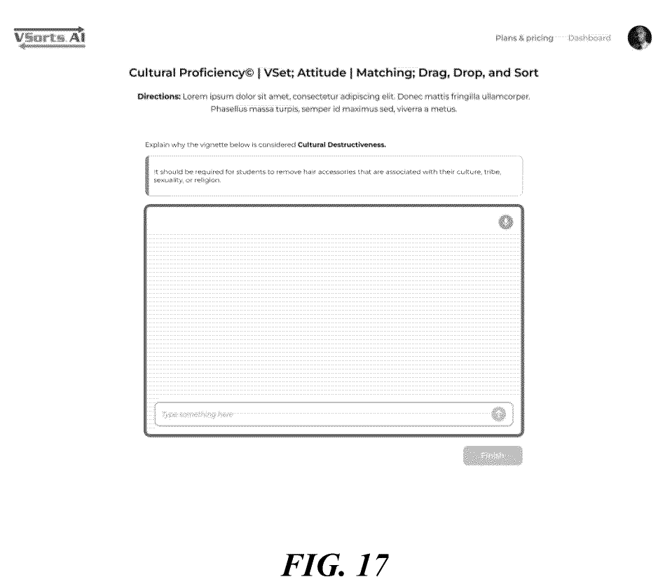

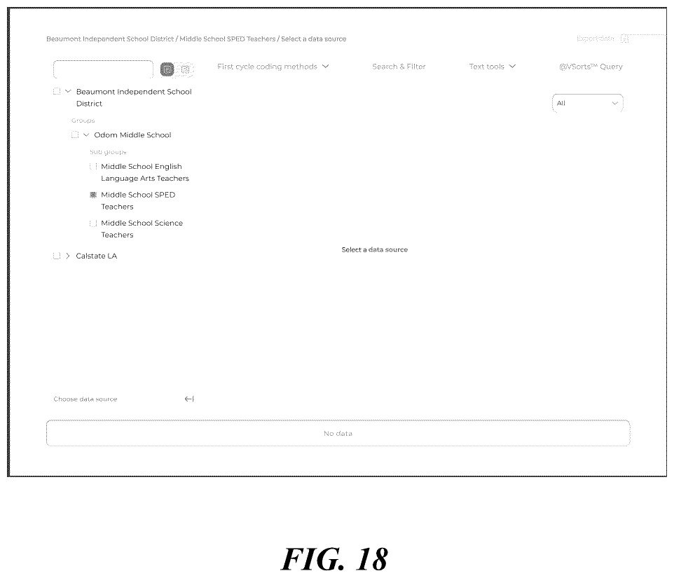

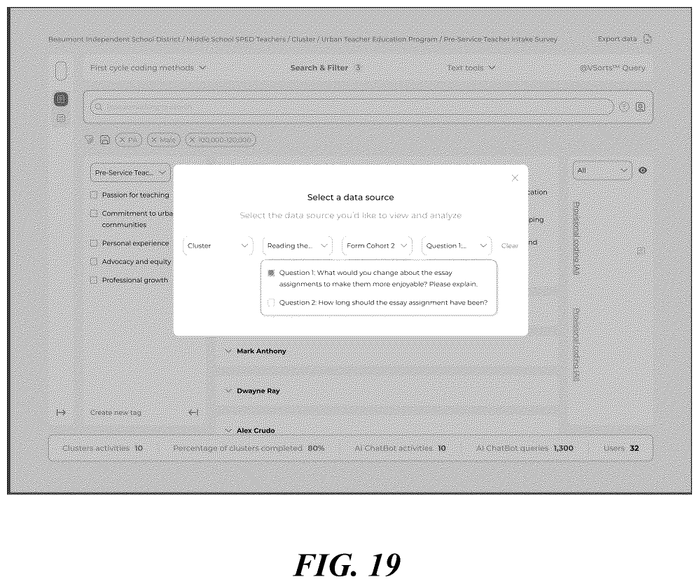

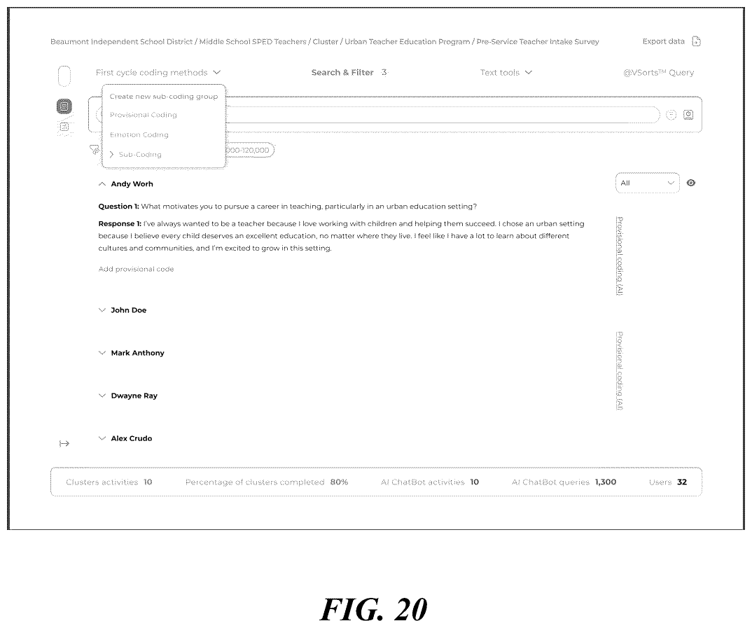

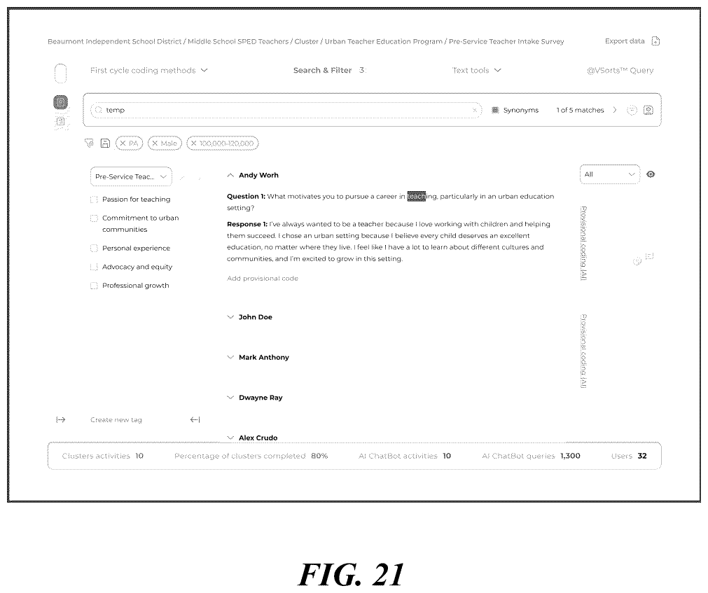

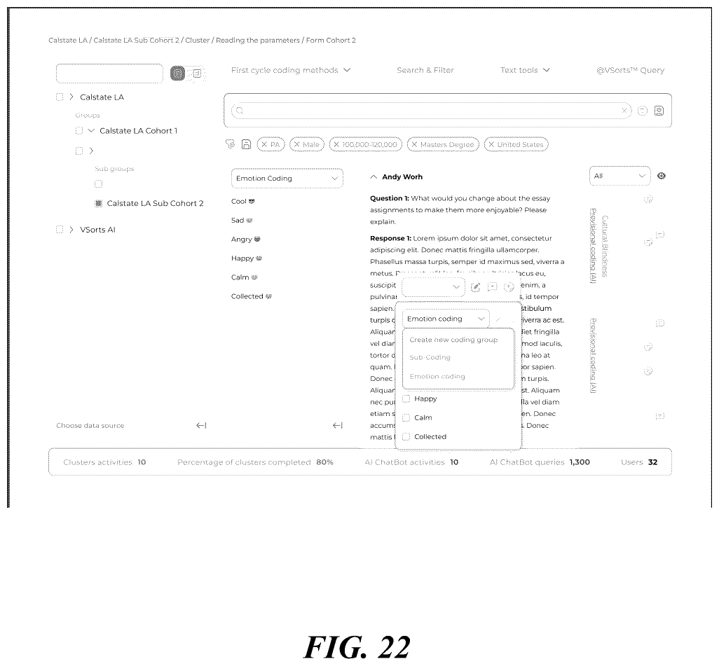

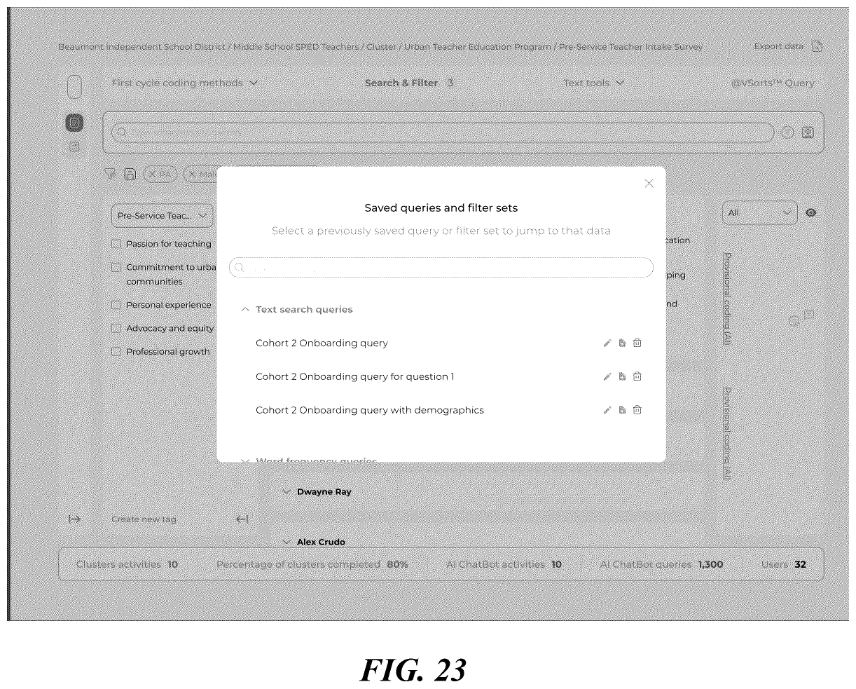

FIGS. 3-8 illustrates a flowchart of the user flow while utilizing the system. FIG. 9 illustrates a block diagram of the software architecture utilized by the system. FIG. 10 illustrates the modular structure of the architecture of the system residing in the cloud and the various actors accessing it. Accessing the User Portal in the frontend are the individual users of an organization. The Admin Portal is accessed by administrators. The results of Cluster activities (e.g., surveys; open ended questions, interview transcriptions) completed by participant users of a particular organization X are analyzed by managers (Admin. Users) of that organization X. The AI model used by the AI scoring engine is trained by AI/ML engineers. The scoring engine that scores the qualitative components of a particular Cluster activities (e.g., open-end survey question, transcribed interview) is validated by human scorers. All actors' access is handled by IAM and all data are stored securely by a relational database system with its own disaster recovery system. The key module in the backend is the cluster engine supported by the scoring engine (AI CoPilots via CRLLM™), the cluster profile and the collaboration engine. Results are handled by the Visualization and reporting engine. Additional modules for further processing are the business intelligence engine and the data exchange modules. FIG. 11 illustrates a schematic of the system's dataflow. FIGS. 12-23 illustrate screenshot of the user interface.

### Business Intelligence Engine

In the realm of qualitative data-informed research (education, market) and human development (cultural competence, motivation), the technical underpinning of the Business Intelligence (BI) Engine stands as a testament to the fusion of advanced analytics, machine learning, and business intelligence tools. This section delves into the architecture of the BI Engine, covering data processing, scoring mechanisms, statistical analyses, and machine learning integration.

Survey responses and expert feedback are securely managed within VSorts™'s multi-tenant distributed database system for data ingestion and pre-processing. The system utilizes Databricks as a data intelligence platform, making use of its Spark cluster and plugin for data loading into an Extract, Transform, Load (ETL) pipeline. This approach enables efficient distributed data cleaning, normalization, and structuring at scale. Transformed data is then stored in AWS S3, the data warehouse, and prepared for integration into the machine learning pipeline.

Regarding the scoring mechanism, tailored algorithms crafted in Python employ cutting-edge deep learning techniques trained with expert-scored survey responses. The system utilizes prominent deep-learning libraries such as PyTorch, TensorFlow, and Transformers in their implementation. Ongoing survey responses and expert-assigned scores undergo pre-processing and are strategically stored in the data warehouse. This data repository empowers continuous assessment and enhancement of AI models responsible for scoring responses, with the goal of creating a dynamic system that seamlessly incorporates human input into its evolution.

In some embodiments, the system provides a mixed-methods analytic platform with a strong focus on qualitative data analysis. Essentially, we see the system AI as a unified system for collecting, structuring, storing, and analyzing multimodal data qualitatively within a single, cohesive platform for intraplatform analysis.

In some embodiments, the systems enables administrative users to create and deploy ChatBots and Cluster, which contain surveys/forms and VSets to collect user data through its Cluster Delivery System (CDS). The CDS facilitates curated data ingestion by seamlessly delivering and requesting user responses to data sources within each cluster. Users can securely access and interact with clusters through their dashboards using Auth0 account credentials. The platform features a suite of AI engines (AI CoPilots) specifically designed and trained for data analysis (e.g., classifying) and coaching for PreK-12 use cases. Additionally, AI CoPilots are modified to deliver real-time and asynchronous coaching through AI Chatbots.

Administrators with permissions can create surveys/forms, select ready-made VSet assessments, and hire relevant AI CoPilots to analyze qualitative data (e.g., open-ended survey responses). Through the CDS, they can deploy these data sources to specific groups and subgroups within their organization. Additionally, they can create and deploy AI ChatBots and hire AI CoPilots to facilitate asynchronous inquiry and coaching. Admins, with appropriate permissions, can analyze and view data from CDS activities and AI ChatBot interactions. The platform supports data export via comma-separated values (CSV) files, allowing PreK-12 administrators or consultants to conduct qualitative data analyses in platforms like NVivo.

In some embodiments, the system provides an analytic dashboard designed to equip PreK-12 school systems with agentic AI tools for on-demand qualitative data analysis directly within the system AI platform, eliminating reliance on external tools like NVivo or SPSS. VSQ will feature agentic AI CoPilots for analysis and coaching, dynamic search and querying tools, and capabilities for inviting external collaborators to support comprehensive data analysis. Proposed R&D efforts will focus on prompt engineering and developing an AI+human UI/UX for qualitative data analysis, enabling few-shot prompting to allow VSQ CoPilots to efficiently analyze or classify datasets based on human-analyzed samples. The platform leverages R scripts and statistical techniques—such as intraclass correlations, kappa coefficients, and ANOVA—to validate coded data across AI+human analysts, ensuring accuracy and reliability. Additionally, VSQ will support the ongoing development of datasets to power AI CoPilots within the AI system and contribute to the development and validation of a sociocultural mixed-expert large language model (LLM).

### Data Exchange Engine

The Data Interchange Module enables seamless communication between the VSorts™ system and external third-party systems, including SaaS platforms. This component empowers organizations to efficiently export data from VSorts™ in various formats compatible with diverse software tools and securely import private organizational data. This bidirectional data flow enhances VSorts™ adaptability and promotes collaborative and interoperable data usage for organizations.

These pipelines undergo thorough evaluation and are integral to the Continuous Integration/Continuous Deployment (CI/CD) pipeline and build process. This framework supports ongoing development and continuous refinement of the export pipeline for optimal performance.

### Data Serialization and Standards:

Supports diverse data serialization formats, including CSV and JSON. Adheres to industry standards like Data Interchange Formats (DIF) and Open Data Protocol (OData) for seamless interoperability with external systems.

### Customizable Export Configurations:

Users can define and save personalized export configurations. Configuration options include selecting data fields, applying filters, and setting export frequency. The enhances user flexibility and meets diverse analytical needs seamlessly.

The Survey Scoring Engine is a critical component in the system, orchestrating the scoring process for survey results. This technical section provides a description of the architecture of the engine, which seamlessly integrates expert rating and annotations and lays the groundwork for future AI-driven scoring with expert validation.

The Disaster Recovery (DR) Engine is a critical component of the VSorts™ system, meticulously designed to ensure the system's resilience and availability, even in the face of unforeseen events.

VSorts™, short for Vignette Sorts, is the essence of this cloud-based platform. It encompasses the VSorts™ Logic, a collection of proprietary APIs seamlessly integrated into the VSorts™ UI. Tailored for specific qualitative data analysis tasks such as classification, sorting, vignette creation, response to vignettes, and prediction, these APIs support ongoing AI/ML training using various methodologies, both supervised and unsupervised. At the heart of their operation is the human-in-the-loop principle, ensuring that human insight and expertise play a pivotal role in shaping and enhancing the machine-learning processes.

Cluster Deployment User Interface: Within VSorts™, Cluster Deployment UI (Clusters) is a specialized tool for deploying digital envelopes, similar to DocuSign, to collect, transcribe, analyze, report, and store both quantitative and qualitative data, facilitating a curated UX for collecting participant user data. Clusters support various activities like surveys, VSets, Lagniappe, document uploads, audio, and video. Access to Clusters is role-based, with users and administrators having designated privileges. Each Cluster represents a set of VSorts™ activities that administrators can design and deploy based on their privileges. This allows for a seamless and customizable experience within the VSorts™ platform.

VSets: This comprehensive component includes Vignettes (text, images, videos), Quantitative Sorts (QS), and Qualitative Inquiries (QI), also known as “Unpacking.” The Unpacking process involves either the administrator or AI analyzing qualitative data collected through QS and delivering the results to the user in seconds. This integrated approach within the VSet ensures a holistic and versatile platform for conducting various QSs and QIs, providing users with realtime, comprehensive, and insightful feedback.

Vignettes: Within VSorts™™, vignettes are expertly crafted compositions comprising text, images, or videos, validated using methodologies like the Delphi approach. These vignettes are customized for various fields, including social science, culture, organization, business, and specific tasks. Integrated into VSets, they play a pivotal role in assessing competencies, biases, and friction through QS, providing a nuanced understanding of user responses. Vignettes within VSets also facilitate nuanced perception analysis through QI, commonly known as unpacking.

Quantitative Sorts (QS): Is a user interface (UI) for data collection through VSets. These VSets contain weighted or predefined vignettes aligned with specific frameworks (e.g., Cultural Proficiency©). Users can interact with the vignettes by dragging, dropping, and sorting them within a VSet using the matching or reacting QS UI. The matching QS includes a tally feature, providing data visualization and reporting flexibility.

Qualitative Inquiries (QI): Is a UI where participant users respond to prompts using vignettes that are flagged during the QS process. The scoring engine analyzes the qualitative data input from participant users in real time, providing them with qualitative data insights. QI interfaces are toggle-controlled and can be added to QS per admin user request.

Survey: VSorts™ allows administrators to collect quantitative and qualitative survey data through various question types, including single-choice, multiple-choice, dropdowns, and text input. This diverse dataset is the foundation for comprehensive analysis, contributing to a holistic understanding of user responses. Open-ended (qualitative) survey questions can be analyzed on demand using the scoring engine, allowing administrators to extract insights from corresponding datasets. Additionally, the survey form features a request option for MP3/MP4 or document uploads, facilitating subsequent data analysis.

Lagniappe: Meaning ‘extra,’ is a library of tools users can use for human development research. A Lagniappe module can be added to a Cluster to enhance the user experience. Lagniappe empowers administrators by allowing them to collect supplementary data beyond

In the VSorts™ ecosystem, the Cluster Engine (Cluster Deployment UI) deploys key sub-components via a digital envelope, including VSets, Surveys, Vignettes, and Lagniappe.

It orchestrates the integration of Cluster Activities to form a complete cluster, incorporating past cluster creation history and setting up criteria for an intelligent generation. This dynamic function streamlines the user experience in VSorts™.

The Cluster Engine automates cluster creation using AI CoPilots. VSorts™ delves into cultural and contextual awareness, combining human-centered design with AI agents trained in social science paradigms. This fusion equips users with metacognitive tools to navigate diverse contexts, reduce biases, and mitigate social risks.

VSorts™ uses social science frameworks like Cultural Proficiency© and collaborates with experts to refine large language models, minimizing biases. This approach ensures that the platform accurately represents diverse cultural contexts. The Cluster Engine enables both manual and automated sub-component generation, making cluster deployment efficient and adaptable for various sectors and organizations.

Realtime Collaboration Engine (Video and Audio Integration): Effective collaboration and communication are crucial for optimizing teamwork, streamlining operations, and nurturing innovation. These practices boost problem-solving, cultivate a positive work environment, and support informed decision-making. At VSorts™, the system prioritizes these principles by seamlessly integrating industry-standard tools and enabling audio and video communication channels. The commitment to scalability, security, and interoperability ensures that the collaboration engine aligns with the evolving needs of modern teams in dynamic work environments.

WebRTC Integration: The Collaboration Engine uses Web Realtime Communication (WebRTC) for realtime audio and video exchange between web browsers. It ensures secure, low latency, and reliable streaming without external plugins.

Role-Based Access Control (RBAC): The system employs RBAC principles to govern access to collaboration features based on user roles, ensuring a secure and personalized experience.

User Presence and Status: The engine manages realtime user presence and status information, enhancing collaboration by providing contextual insights into colleagues' availability.

Integration with Third-Party Tools: The system seamlessly integrates with tools like Zoom, Microsoft Teams, and Google Meet, enabling users to transition between platforms effortlessly and enhancing the overall user experience.

Multi-Channel Communication: Users can engage in one-on-one and group video and audio sessions and realtime text-based communication within the platform.

Screen Sharing and Document Collaboration: Screen sharing and realtime document collaboration are facilitated through the WebRTC protocol and integration with tools like Google Docs and Microsoft 365.

Secure Communication Protocols: The system ensures robust security with protocols like SRTP for audio/video encryption and TLS for data transmission.

Scalability and Load Balancing: The engine operates within a containerized environment with Kubernetes for load balancing, ensuring optimal resource utilization and high availability.

Recording and Archiving: Users can record collaboration sessions, with recorded sessions processed and transcribed for documentation and easy access.

Deployment UI, data analysis tools, AI integration, and admin dashboards, ensuring that the software optimally serves the users.

The AI Training Engine plays a pivotal role in enhancing the functionality of both the scoring and cluster engines. In the rapidly evolving AI industry, the commitment is to maintain leadership by systematically evaluating and improving the VSorts™ Logic. This involves establishing an ongoing validation and enhancement mechanism through the AI training engine. Manual scoring of responses by domain experts provides valuable ground truth data, forming the basis for continuous AI Scoring model training. Domain SME initially create clusters, allowing the Cluster Generation AI to learn and autonomously generate optimal clusters. The AI training engine serves a dual function, fine-tuning and enhancing both the scoring and cluster engines, making it integral to the overall advancement of VSorts™ SaaS AI.

Data Availability: Survey responses, expert-scored survey results, and cluster generation data are securely stored in the multitenant database system. This data undergoes continuous processing through the robust data pipeline, where it is meticulously transformed, tagged, and archived in the data warehouse. The data warehouse serves as a repository of valuable information, providing the AI training engine with resources for ongoing enhancement and optimization.

Feature Engineering: In response to the continual influx of new data, the system consistently evaluates potential improvements to the feature set in both scoring and cluster models. This ongoing assessment aims to optimize the model by incorporating up-to-date information. The integration of new data into the feature engineering process not only elevates prediction precision but also underscores the system's adaptability to dynamic data landscapes inherent in the AI industry.

Iterative Model Training: With an increasing volume of accessible data, the system continually refines the scoring and cluster generation models for ongoing improvements. This iterative approach facilitates model adaptation to evolving data dynamics, enhancing their capabilities. Adjustments to model parameters can be made in response to shifts in data patterns and industry requirements.

Version Control: Given the iterative framework in the model training process, the AI training engine incorporates robust version control. Each incremental adjustment to model parameters is systematically assigned version numbers and securely archived in the dedicated model repository. This approach allows us to maintain a comprehensive record of the entire evolution of the AI models and facilitates model checkpointing for strategic utilization.

Scalable Computing: AI model training requires significant resources, leading to the establishment of a distributed cloud-based computing platform. These routines operate within containerized environments, ensuring efficient use of time and facilitating a seamless, conflict-free, and dependable training process.

Robust Quality Assurance Protocols: Comprehensive Quality Assurance Protocols are crucial in the progression and implementation of artificial intelligence models. Formulated to ensure precision, dependability, and overall quality of the models, these protocols are integrated into the Integration with an AI training engine involves meticulous examination encompassing diverse scenarios, edge cases, and real-world data to substantiate the model's capacity for generalization and resilience. Elevated benchmarks for accuracy and reliability serve to guarantee optimal AI system performance under diverse conditions.

Human-in-the-Loop Validation: Human-in-the-loop validation procedures introduce nuanced assessment beyond automated systems' capability. The AI models undergo evaluation by skilled human assessors, yielding valuable insights into model efficacy and facilitating continuous improvements for overall reliability.

Unless otherwise defined, all technical and scientific terms used herein have the same meaning as commonly understood by one of ordinary skill in the art to which this invention belongs. All publications, patent applications, patents, and other references mentioned herein are incorporated by reference in their entirety to the extent allowed by applicable law and regulations. The systems and methods described herein may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

The foregoing is provided for purposes of illustrating, explaining, and describing embodiments of this disclosure. Modifications and adaptations to these embodiments will be apparent to those skilled in the art and may be made without departing from the scope or spirit of this disclosure.

As used herein and in the appended claims, the singular forms “a”, “an”, and “the” include plural referents unless the context clearly dictates otherwise.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

In many instances entities are described herein as being coupled to other entities. It should be understood that the terms “coupled” and “connected” (or any of their forms) are used interchangeably herein and, in both cases, are generic to the direct coupling of two entities (without any non-negligible (e.g., parasitic) intervening entities) and the indirect coupling of two entities (with one or more non-negligible intervening entities). Where entities are shown as being directly coupled together or described as coupled together without description of any intervening entity, it should be understood that those entities can be indirectly coupled together as well unless the context clearly dictates otherwise.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described herein. A variety of modifications and variations are possible in light of the above teachings without departing from the following claims.

What is claimed is:

1. A system for identifying social, cultural, and contextual bias for personal and organizational users, the system comprising:
at least one user computing device in operable connection with a user network;
an application server in operable communication with the user network, the application server configured to host an application program for identifying social, cultural, and contextual bias for personal and organizational users, the application program having a user interface module for providing access to the application program via the at least one user computing device; and
an AI engine to provide qualitative analysis in a user interface for identifying at least one of the following: a social bias, a cultural bias and a contextual bias and to provide analysis related to the social, the cultural and the contextual bias.

2. The system of claim 1, wherein a display module provides one or more cluster activities comprised of at least one of the following: a survey, a question, and an interview transcript.

3. The system of claim 2, wherein the AI engine operates a scoring engine to score one or more qualitative components, wherein the one or more qualitative components are comprised of the social, the cultural and the contextual bias, and wherein the one or more qualitative components are gathered from the one or more cluster activities.

4. The system of claim 3, further comprising a cluster engine in operable communication with the scoring engine and the AI engine evaluate and improve scoring of the social bias, the cultural bias, and the contextual bias.

5. The system of claim 4, further comprising a collaboration engine in operable communication with the scoring engine and the cluster engine, wherein the collaboration engine integrates two or more data sources.

6. The system of claim 5, further comprising a visualization and reporting engine in operable communication with the display module to display results associated with the one or more cluster activities.

7. The system of claim 6, further comprising a business intelligence engine to securely manage one or more responses to the one or more cluster activities.

8. The system of claim 7, further comprising a data exchange module enables transmission of data between two or more data sources.

9. A system for identifying social, cultural, and contextual bias for personal and organizational users, the system comprising:
at least one user computing device in operable connection with a user network;
an application server in operable communication with the user network, the application server configured to host an application program for identifying social, cultural, and contextual bias for personal and organizational users, the application program having a user interface module for providing access to the application program via the at least one user computing device;
an AI engine to provide qualitative analysis in a user interface for identifying at least one of the following: a social bias, a cultural bias and a contextual bias and to provide analysis related to the social, the cultural and the contextual bias, wherein the AI engine is in operable communication with an AI training engine to provide automated examination of the qualitative analysis; and
a human-in-the-loop protocol to enable human assessment of the qualitative analysis.

10. The system of claim 9, wherein a display module provides one or more cluster activities comprised of at least one of the following: a survey, a question, and an interview transcript.

11. The system of claim 10, wherein the AI engine operates a scoring engine to score one or more qualitative components, wherein the one or more qualitative components are comprised of the social, the cultural and the contextual bias, and wherein the one or more qualitative components are gathered from the one or more cluster activities.

12. The system of claim 11, further comprising a cluster engine in operable communication with the scoring engine and the AI engine evaluate and improve scoring of the social bias, the cultural bias, and the contextual bias.

13. The system of claim 12, further comprising a collaboration engine in operable communication with the scoring engine and the cluster engine, wherein the collaboration engine integrates two or more data sources.

14. The system of claim 13, further comprising a visualization and reporting engine in operable communication with the display module to display results associated with the one or more cluster activities.

15. The system of claim 14, further comprising a business intelligence engine to securely manage one or more responses to the one or more cluster activities.

16. The system of claim 15, further comprising a data exchange module enables transmission of data between two or more data sources.

17. The system of claim 16, wherein the user interface module provides a plurality of vignettes to prompt a user to input a response, and wherein the response is transmitted to the scoring engine capable of analyzing the response to provide the user with one or more qualitative insights in real-time.

18. The system of claim 17, wherein the plurality of vignettes each include at least one of the following: a text, an image, and a video.

19. A method for identifying social, cultural, and contextual bias for personal and organizational users, the method comprising the steps of:
displaying a plurality of prompts via a user interface module;
inputting, via a user, a response to each of the plurality of prompts;
identifying, via an AI engine, at least one of the following present in the plurality of prompts: a social bias, a cultural bias and a contextual bias;
providing, via the AI engine and a scoring engine, analysis related to the social, the cultural and the contextual bias, wherein the AI engine is in operable communication with an AI training engine to provide automated examination of the qualitative analysis.
